(19) United States
(12) Patent Application Publication
(10) Pub. No.: US 2008/0129517 A1
(43) Pub. Date: Jun. 5, 2008

(54) Control System With Alarm

(75) Inventors: Peter Andrew Crosby, Manly (AU); Roberto Tripodi, Five Dock (AU)

Correspondence Address: MCCARTER & ENGLISH , LLP STAMFORD OFFICE, FINANCIAL CENTRE , SUITE 304A, 695 EAST MAIN STREET, STAMFORD, CT, 06901-2138, US

(73) Assignee: VENTRASSIST PTY LTD, Chatswood (AU)

(21) Appl. No.: 11/943,406

(22) Filed: Nov. 20, 2007

(30) Foreign Application Priority Data
Nov. 24, 2006 (AU) 2006906614

(51) Int. Cl. G08B 23/00

(52) U.S. Cl. 340/573.1

(57) ABSTRACT

A control system for use with a medical device implanted within a patient. The system is included within a control circuit connected to a medical device and when said control circuit detects at least one error with the medical device or patient, the controller activates at least one audible alarm and wherein the audible alarm plays a voice message to the patient through an audio transducer, and the speaker of the audio transducer is disposed externally relative to the body of the patient.

### TECHNICAL FIELD

The present invention relates to an improved control system for use with a medical device, wherein the control system includes an improved alarm system or method.

### BACKGROUND

There are presently available many medical devices to treat various patient aliments. Of these medical devices, implantable medical devices (“IMD”) are a subset relating to medical devices which are implanted within the body of a patient, when in use. Generally, IMDs include: pacemakers; left ventricle assist devices (“LVAD”); hearing implants; neural simulators; implantable defibrillators; and blood pumps. All of these IMDs require a power source and a control system to drive the IMD.

Typically, the control systems for IMDs have included audible and visual alarms to alert patients and doctors to any problems, errors or faults with the patient or the IMD. When the patient or doctor hears or sees the alarm, they then may take immediate action to remedy the error, fault or problem. According to this specification, the term error is defined in a non-limiting manner to include faults, errors or problems associated with patients or IMDs.

U.S. Pat. No. 4,832,033 (Maher et al) describes an alternate alarm system for use with a muscle simulation system, wherein when the medical device is electrically connected to a personal computer (PC), a voice alarm is generated. The advantages of a voice alarm is that it usually obtains or draws the attention of the patient or doctor much quicker than other forementioned alarms and that the voice alarm instantly informs the doctor or patient of the exact problem without the patient or doctor having to interpret visual alarms which usually include error codes.

The main disadvantage with the invention described in '033 is that the medical device must be connected to the PC for the alarm to be activated which is not desirable in emergency situations or situations of life support such as LV ADs. Additionally, the medical device in this invention is not implantable.

U.S. Pat. Nos. 6,067,473 and 6,247,474 (Greeninger et al) describe inventions generally relating to an alarm system connected to a pacemaker. The alarm system includes an audio transducer. However, the audio transducer is implanted under the skin layer of patient leading: to increased risk of infection, increased costs of manufacturing and also muffling the amplitude of the audio output from the transducer.

Additionally, the device described is primarily designed to be used by a doctor or clinician. The doctor or clinician typically listens to the pre-recorded voice message played at a low level by the transducer through a stethoscope. The system increases the volume for patient voice messages but the sound generated may be considerably muffled by the skin layer of the patient. The high volumes associated with audio transducer for alerting patient may also cause vibration and discomfort within the patient.

U.S. Pat. No. 6,450,172 (Hartlaub et al) describes an improved system beyond the described in '473 and '474 wherein the audio transducer is replaced with a RF transmitter. This system overcomes some of the disadvantages with the above mentioned earlier systems. However, the system is generally more expensive to manufacture and requires a RF receiver for the voice messages to be played back to the patient or doctor. This complicates the system and may provide the potential for failure of the alarm system, if the RF receiver does not receive the alarm message broadcast via RF. It also provides no backup if the RF receiver fails.

Furthermore, none of the aforementioned systems have the capacity to allow voice messages to be recorded and individualized to the patient's requirement in terms of local language and accent. Rather according to above discussed disclosures, the voice messages are pre-recorded at the factory when the device is manufactured and cannot be altered.

The present invention aims to or at least address or ameliorate one or more of the disadvantages associated with the above mentioned prior art.

### SUMMARY OF THE INVENTION

According to a first aspect the present invention consists in a control system for use with a medical device implanted within a patient, wherein said system is included within a control circuit connected to said medical device and when said control circuit detects at least one error with said medical device or patient, said controller activates at least one audible alarm and wherein the audible alarm plays a voice message to said patient through an audio transducer and characterised in that the speaker of said audio transducer is disposed externally relative to the body of the patient.

Preferably each error corresponds to a different voice message.

Preferably at least one voice message may be changed after the control system has been manufactured.

Preferably at least one voice message may be recorded and stored by the control system, when a user speaks in the audio transducer.

Preferably at least one voice message may be stored by the control system, after being recorded and transmitted by a personal computer connected to said control system.

Preferably the medical device is a left ventricular assist device.

According to a second aspect the present invention consists in a portable external controller adapted to be operably connected to a blood pump implanted within a patient said controller comprising a control circuit for monitoring and controlling the operation of said pump, an audible alarm device operably connected to said control circuit and a battery for powering said pump via said control circuit, said audible alarm device transmitting at least one voice message to said patient upon said control circuit detecting a predetermined state of operation of said pump and/or battery.

According to a third aspect the present invention consists in a an audible alarm device operably connected to a control circuit for monitoring and controlling the operation of a battery powered blood pump disposed within a patient, said alarm device and said control circuit both disposed within a portable housing external of said patient, said audible alarm device transmitting at least one voice message in the vicinity of said patient upon said control circuit detecting a predetermined state of operation of said pump.

### BRIEF DESCRIPTION OF THE DRAWINGS

Embodiments of the present invention will now be described with reference to the accompanying drawings wherein:

FIG. 1 depicts a schematic view of a first preferred embodiment of the present invention; and

FIG. 2 depicts a further schematic of the first preferred embodiment as depicted in FIG. 1.

### BRIEF DESCRIPTION OF THE PREFERRED EMBODIMENTS

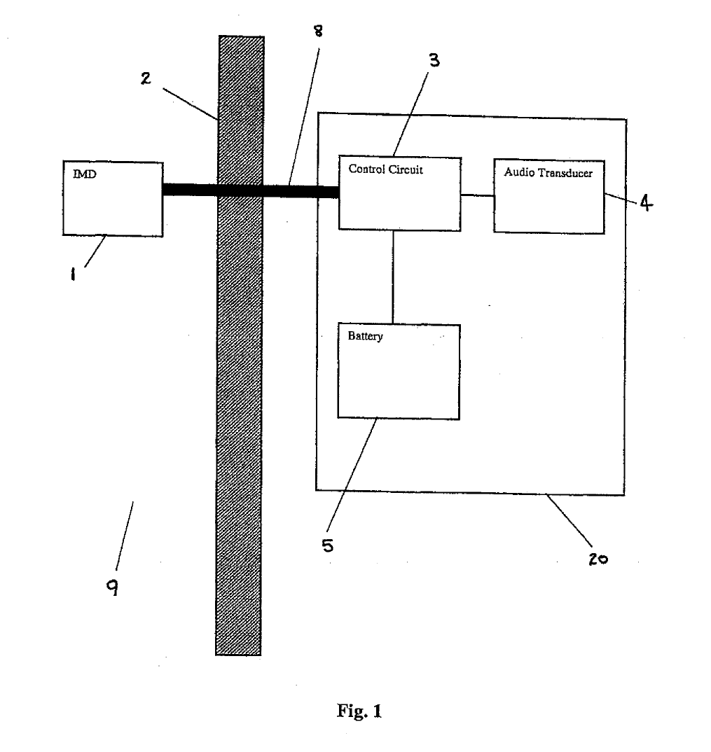

A first preferred embodiment of the present invention is depicted in FIG. 1. An implantable Medical Device (IMD) t is connected to an external controller 20 by way of a percutaneous lead 8 extending through the skin layer 2 of the patient 9. In this embodiment, the external controller 20, comprises a controller circuit 3, a battery 5 and an alarm speaker 4, all of which are preferably encapsulated within a controller housing 20. Preferably, the IMD 1 may be an implantable blood pump or a left ventricle assist device of the type described in U.S. Pat. No. 6,227,797—Watterson et al. The blood pump may be connected in parallel with the normal blood circulation of the patient and may be specifically connected between the apex of the left ventricle of the heart and the ascending portion of the aorta. Please note that other configurations are possible and within the scope of this specification.

The controller circuit 3 supplies a drive voltage or current to the IMD 1 for the IMD 1 to function. Additionally, the controller circuit 3 may change or amend the functioning of the IMD 1. In the case, that the IMD 1 is an implantable blood pump, the controller circuit 3 may increase or decrease the pumping speed in accordance with manual inputted data, and/or physiological control derived the patient's physiological parameters.

Preferably, the control circuit 3 also may be able to detect errors from the IMD 1 or patient 9. Specifically, the control circuit 3 may detect some of the following errors including: disconnection of the IMD 1 from the controller 3; low blood flow alarms; high or excessive power drains of IMD 1; high blood flow alarms; out of range blood pressures, flow, or pulsatility indexes; battery or power failures; situations that require controller replacement such as controller failure; low power; failure of batteries or power sources.

Preferably, when the control circuit 3 detects one or more of the said errors or faults, the control circuit 3 initiates an specialized alarm system. The system matches the error or fault with a pre-recorded voice message and plays the pre-recorded voice message using alarm speaker 4. The voice message 6 is then audible to patient and tells the patient that something is wrong with the IMD or controller.

Preferably, the pre-recorded voice message 6 tells the patient what the error or fault is and what action the patient should take to correct the problem.

In this embodiment, the alarm system may be activated by the control circuit 3 detecting a low or flat battery 5. The alarm system then plays a pre-recorded voice message 6 across the alarm speaker 4 that may state for example “low battery power, please replace battery”. Additionally, the alarm system may continue to play the voice message at regular intervals until the corrective action is taken, which in this case is to replace or recharge the battery.

Also, the alarm system may also be activated by an emergency situation such as the power source being disconnected or not providing any power. In this case, the alarm speaker 4 may play a pre-recorded voice message that states “No power, please battery or connect to AC power immediately”. This second voice message may be significantly louder than the first message due to its importance. Additionally, the alarm system may play the pre-recorded message continuously with increasing volume.

By way of example other voice messages may include: “Low flow—please contact clinician”; “high flow—please contact clinician”; or “controller failure—please contact clinician immediately”.

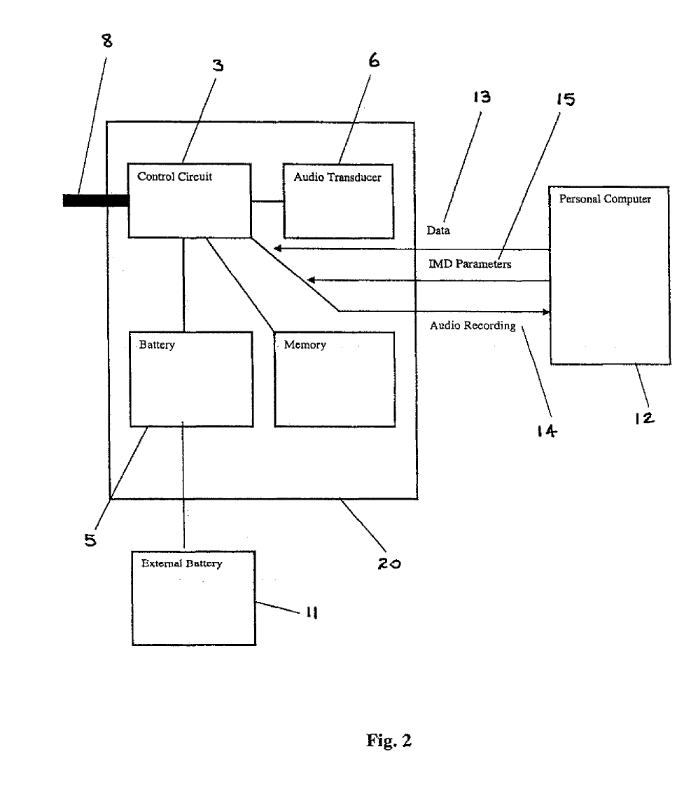

In FIG. 2, the first preferred embodiment is shown in greater detail wherein the controller 20 is connected to an external personal computer (PC) 12. Generally, clinicians use a PC 12 to program the controller with all of the control and operating parameters necessary to operate the IMD 1 prior to implantation.

In this illustration, the controller 20 additionally includes a memory module 10. The memory module may be used to store physiological data, operating parameters of IMD 1; or the aforementioned voice messages 6. Preferably, the voice message 6 may be recorded and stored in any standard audio file format including WAV, MP3 or WMA formats. Also, it is preferable to use non-volatile memory in the memory module 10 so that is if the battery 11 is replaced or completely discharges, the voice messages 6 are not lost or deleted.

The pre-recorded voice messages 6 may be recorded and stored when the controller 20 is manufactured and the voice messages 6 may also be recorded differently for each jurisdiction. This may make it possible for voice alarms 6 to be recorded and stored in different languages and accents to increase the usability of the overall system.

Additionally, clinicians may be able to override the factory pre-recorded voice messages 6 with their own messages, as desired. The clinician may be able to use the graphical user interface (GUI) running on the PC 12 to record and program new or alternative voice messages and alarms into a desired audio file format and download the files into the memory module 10. Thereby allowing the clinician further flexibility with alarm and messages given to the patient.

In further embodiments of the present invention, the voice messages 6 may be interlaced with ordinary alarm tones to get the attention of the patient. For example, a multi tone buzz or noise may be generated by the alarm speaker 4 and then the prerecorded voice message 6 follows it.

A further modification to the first preferred embodiment may also be to allow the alarm speaker 4 to function as a microphone in certain circumstances. For example, the clinician may be able to initiate a recording mode on the controller and speak into the alarm speaker 4. The control circuit 3 then receives the audio input from the alarm speaker 4 and records this in a file preferred file format in the memory module 10. The alarm system may playback this recorded voice message at the appropriate time when activated by an error or fault.

It may also be desirable to store multiple language sets of pre-recorded voice messages for use in different jurisdictions around the world. During the setup of the controller, a person may be able to select a desired language set and the voice messages used will play back in only that language and/or accent, as appropriate to jurisdiction which the IMD 1 has been implanted.

The above descriptions detail only some of the embodiments of the present invention. Modifications may be obvious to those skilled in the art and may be made without departing from the scope and spirit of the present invention.

1. A control system for use with a medical device implanted within a patient, wherein said system is included within a control circuit connected to said medical device and when said control circuit detects at least one error with said medical device or patient, said controller activates at least one audible alarm and wherein the audible alarm plays a voice message to said patient through an audio transducer and characterised in that the speaker of said audio transducer is disposed externally relative to the body of the patient.

2. The control system of claim 1, wherein each error corresponds to a different voice message.

3. The control system of claim 2, wherein at least one voice message may be changed after the control system has been manufactured.

4. The control system of claim 3, wherein at least one voice message may be recorded and stored by the control system, when a user speaks in the audio transducer.

5. The control system of claim 3, wherein at least one voice message may be stored by the control system, after being recorded and transmitted by a personal computer connected to said control system.

6. The control system of claim 5, wherein the medical device is a left ventricular assist device.

7. A portable external controller adapted to be operably connected to a blood pump implanted within a patient said controller comprising a control circuit for monitoring and controlling the operation of said pump, an audible alarm device operably connected to said control circuit and a battery for powering said pump via said control circuit, said audible alarm device transmitting at least one voice message to said patient upon said control circuit detecting a predetermined state of operation of said pump and/or battery.

8. An audible alarm device operably connected to a control circuit for monitoring and controlling the operation of a battery powered blood pump disposed within a patient, said alarm device and said control circuit both disposed within a portable housing external of said patient, said audible alarm device transmitting at least one voice message in the vicinity of said patient upon said control circuit detecting a predetermined state of operation of said pump.
